(19) United States
(12) Patent Application Publication
(10) Pub. No.: US 2022/0283565 A1
(43) Pub. Date: Sep. 8, 2022

(54) SYSTEM AND METHOD FOR FACILITATING AN EFFICIENT HYBRID-MANUFACTURING PROCESS PLAN

(71) Applicant: Palo Alto Research Center Incorporated, Palo Alto, CA (US)

(72) Inventors: Krishna M. Kalyanam, Campbell, CA (US); Morad Behandish, Foster City, CA (US)

(73) Assignee: Palo Alto Research Center Incorporated, Palo Alto, CA (US)

(21) Appl. No.: 17/191,583

(22) Filed: Mar. 3, 2021

(51) Int. Cl. G05B 19/4099; G06Q 50/04; G06Q 10/06; B33Y 50/00; B29C 64/386

(52) U.S. Cl. CPC G05B 19/4099; G06Q 50/04; G06Q 10/06316; B33Y 50/00; B29C 64/386; G05B 2219/35134; G05B 2219/32423

(57) ABSTRACT

Embodiments described herein provide a system for facilitating a process plan for manufacturing an object. During operation, the system can determine a target search space based on a set of constraints. The target search space can include a set of manufacturing actions associated with a manufacturing process of the object. A respective manufacturing action can include an additive or subtractive manufacturing operation corresponding to the addition or removal of a predefined region of the object, respectively. The system can then traverse a set of sequence of actions in the target search space based on a search operation and select a sequence of actions satisfying a target objective as the process plan. A respective sequence of actions can include one or more manufacturing operations capable of producing the object. Subsequently, the system can provide the process plan to a controller configured to manage the manufacturing process of the object.

### STATEMENT OF GOVERNMENT-FUNDED RESEARCH

This invention was made with U.S. government support under (Contract Number) Award Number: HR0011-17-2-0030 awarded by the Defense Advanced Research Projects Agency (DARPA) of the Department of Defense (DoD). The U.S. government has certain rights in the invention.

### BACKGROUND

### Field

This disclosure is generally related to hybrid manufacturing planning. More specifically, this disclosure is related to a system and method for determining a sequence of operations for a hybrid manufacturing process plan.

### Related Art

Computing manufacturing plans for pre-designed 3-dimensional (3D) objects is at the frontier in artificial intelligence (AI). Different types of manufacturing technologies are available for manufacturing complex 3D structures. Specifically, additive manufacturing (AM) technology can be used to manufacture complex 3D objects by adding materials in a layered fashion, e.g., adding material by a 3D printer. Subtractive manufacturing (SM) technology can also be used to manufacture 3D objects by removing material, e.g., by cutting, drilling, grinding, and boring a block of material to a desired form within a specified tolerance. Some manufacturing technologies leverage the advantages of AM and SM by combining the two for fabricating the 3D object. For example, there are hybrid “multi-task” machines on the market that use the same computer numerically-controlled (CNC) motion system with a set of replaceable AM nozzles (e.g., for laser cladding) and SM spindles (e.g., for face/form milling). AM and SM may be performed separately, e.g., by separate machines, and may result in additional re-fixturing and post-processing operations before transitioning from one manufacturing technology or device to another. Such additional post-processing can result in increased time-to-market and can also increase the cost of manufacturing the 3D object.

With the advancement in manufacturing technologies, new systems can combine AM and SM techniques in a single machine to perform a hybrid manufacturing (HM) process. Current HM approaches typically first complete AM steps to produce a “near-net” shape (which is referred to as a scaffolding process), followed by SM steps to remove the extra support materials and finish the functional surfaces down to proper tolerances. Further, an approach that would allow interleaving of AM and SM steps in nontrivial ways would increase the range of 3D objects that can be manufactured or enable more cost-effective manufacturing by optimization of how these steps are ordered. The process of determining the existence of such an ordering and its optimization can be referred to as HM process planning. Performing HM process planning in an efficient manner is challenging.

### SUMMARY

Embodiments described herein provide a system for facilitating a process plan for manufacturing an object. During operation, the system can determine a target search space based on a set of constraints, which can constraint a possible search space. The target search space can include a set of manufacturing actions associated with a manufacturing process of the object. A respective manufacturing action can include an additive or subtractive manufacturing operation corresponding to the addition or removal of a predefined region of the object, respectively. The system can then traverse a set of sequence of actions in the target search space based on a search operation and select, from the set of sequence of actions, a sequence of actions as the process plan. The selected process plan can satisfy a target objective. A respective sequence of actions can include one or more manufacturing operations capable of producing the object. Subsequently, the system can provide the process plan to a controller configured to manage the manufacturing process of the object.

In a variation on this embodiment, a respective manufacturing operation corresponds to a primitive indicating a three-dimensional (3D) region of influence (ROI) for the object.

In a further variation, intersections of a set of primitives associated with the set of manufacturing actions can indicate a plurality of atoms. A respective atom can indicate whether the atom is included in a respective of the set of primitives.

In a further variation on this embodiment, the system can determine the target search space also by applying a set of restrictions on the search space associated with the manufacturing process of the object.

In a further variation, the set of restrictions can include one or more of: a predefined order of a subset of manufacturing operations and an enhancement to the search operation.

In a further variation on this embodiment, the system can generate a structured representation of the search operation based on the set of constraints and perform the search operation on a solver based on the structured representation.

In a further variation on this embodiment, the structured representation can be a linear program, and the solver can include a mixed integer linear programming solver.

In a variation of this embodiment, the search operation includes one or more of: a simplex algorithm, a cutting plane method, a branch and bound method, and a branch and cut method.

In a variation on this embodiment, the system can determine a weighted volumetric cost for a respective of the set of sequence of actions. The system can then select the sequence of actions by determining that the volumetric cost for the sequence of actions satisfies the target objective.

In a further variation on this embodiment, the system can control the execution of the one or more manufacturing operations in an order indicated by the sequence of actions.

### BRIEF DESCRIPTION OF THE FIGURES

FIG. 1 illustrates an exemplary manufacturing management system for determining an efficient HM process plan, in accordance with an embodiment of the present application.

FIG. 2A illustrates exemplary schematics of different HM process plans based on different sequences of a set of manufacturing primitives, in accordance with an embodiment of the present disclosure.

FIG. 2B illustrates an exemplary schematic of overlapping the set of manufacturing primitives, in accordance with one embodiment of the present disclosure.

FIG. 2C illustrates an exemplary schematic of a plurality of manufacturing atoms that result from the intersection of the set of manufacturing primitives and their complements, in accordance with one embodiment of the present disclosure.

FIG. 3 illustrates an exemplary process of determining an efficient HM process plan, in accordance with an embodiment of the present application.

FIG. 4A presents a flowchart illustrating a method of a process management system determining an efficient HM process plan, in accordance with an embodiment of the present application.

FIG. 4B presents a flowchart illustrating a method of a process management system determining a sequence of primitives corresponding to an efficient HM process plan, in accordance with an embodiment of the present application.

FIG. 5 presents a flowchart illustrating a method of a process management system executing a sequence of manufacturing primitives based on an efficient HM process plan, in accordance with an embodiment of the present application.

FIG. 6 illustrates an exemplary computer system facilitating a manufacturing management system capable of determining an efficient HM process plan, in accordance with an embodiment of the present application.

FIG. 7 illustrates an exemplary apparatus that facilitates a manufacturing management system capable of determining an efficient HM process plan, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The embodiments described herein solve the problem of efficiently manufacturing an object by (i) defining the solution space based on a set of constraints and/or restrictions, and (ii) determining, from the solution space, a sequence of manufacturing primitives that can efficiently manufacture an object. A respective manufacturing primitive can correspond to an additive or a subtractive manufacturing (AM/SM) action.

Typically, to manufacture an object, a hybrid manufacturing (HM) process plan based on a set of additive and subtractive manufacturing (AM/SM) actions is produced. With existing technologies, a respective manufacturing operation usually follows a predefined trajectory. Consequently, such a respective operation can only facilitate a particular component of an object being manufactured. To produce the object, a sequence of such operations is needed. For example, if a three-dimensional (3D) printer's nozzle moves with a horizontal trajectory, the corresponding AM operation (i.e., the 3D printing operation) can only produce elements restricted by the horizontal trajectory. Similarly, if a milling device moves with a vertical trajectory, the corresponding SM operation (i.e., the milling operation) can only subtract elements from a larger component restricted by the vertical trajectory. If the operations are not efficiently sequenced, an operation may alter an element generated by another operation, thereby leading to additional and ineffective operations.

To solve this problem, a manufacturing management system can efficiently determine a sequence of operations that can efficiently produce the target object while satisfying an objective (e.g., cost, operation, or energy minimization). The system can determine a sequence of AM/SM actions in a cost-effective and efficient way to manufacture the object. As described in U.S. Pat. No. 10,719,069, each manufacturing action is defined as Boolean set operations with a manufacturing “primitive” defining 3D region of influence (ROI) for the action. Every AM action is defined as a set union with a given AM primitive, whereas every SM action is defined as a set difference with a given SM primitive. Each primitive is computed by analyzing the geometry of the target shape against the tool shape, machine degrees of freedom, and possibly other manufacturing parameters. The primitives and their complements are intersected to generate a decomposition of the 3D space, called canonical or “atomic” decomposition. Each manufacturing “atom” corresponds to a set of points in 3D space that is classified in the same way against all primitives in terms of inclusion.

In one embodiment, the atoms may be encoded as a sequence of binary digits that classify the atom, e.g., given four primitives, an atom encoded “1001” can be included inside first and fourth primitives and excluded from second and third primitives. A necessary condition for the existence of an HM process plan (or HM plan) that generates a desired final state including a subcollection of atoms is an approximation of the target shape, using those atoms, within user-specified tolerances. During operation, the system may derive a set of constraints that define how the AM/SM actions corresponding to AM/SM primitives can be ordered in an HM process plan, thereby ensuring that the process plan generates the target shape of the object. An HM process plan (or a “plan”) is defined by a sequence of manufacturing actions represented by AM/SM primitives. A plan is “valid” if it represents a meaningful sequence of AM/SM actions that makes use of AM primitives via set unions and complements of SM primitives via set intersections. A plan is “feasible” if it produces the target shape, or an approximation of it as deemed sufficiently accurate by user-specified tolerances or other design constraints. A necessary and sufficient condition for a plan to be feasible is to have every atom inside the target shape present in the outcome of the sequence, and every atom outside the target shape absent at the end of the sequence.

There can be a search space of feasible plans comprising a set of feasible plans with the same subcollection of atoms being present. These feasible plans may have different costs associated with them because the actual number of times a given atom may be turned on/off by different primitives that contain that atom may be different from one feasible plan to another. Examples of the cost can include, but are not limited to, monetary cost, energy consumption, time duration, ease of access, and computational load. Each primitive may be associated with a different cost per unit volume of the atoms that it affects, depending on a number of process parameters. A feasible plan is “cost-effective” if the cost it within a threshold, which may be defined in different ways depending on manufacturing budget, computational budget, and optimality criteria. A feasible plan is “near-optimal” (or “optimal”) if it is relatively cost-effective than most other (or all other) feasible plans. A feasible plan is “optimized” if it is obtained by applying an optimization process, including a combinatorial search or numerical optimization, subject to feasibility constraints.

The system can traverse the feasible solution space of sequences based on the constraints and determine a sequence of operations that can satisfy the objective. In some embodiments, the system can apply a set of restrictions (e.g., the first operation should be an AM operation) to restrict the feasible solution space and generate a target solution space. The restrictions can also include relaxation techniques, such as the removal of integrality and column generation. By applying a traversal or searching mechanism on the target solution space, the system can perform a search operation and efficiently determine the sequence. Examples of the searching mechanism can include, but are not limited to, the simplex algorithm, cutting plane methods, the branch and bound method, and the branch and cut method.

The system can continue to traverse the target search space as long as at least one solution can be found. For example, if the branch and cut method is used, the system can solve a series of continuous sub-problems in the search space. By traversing the sub-problems, the system can determine the solution. Furthermore, the system can determine one or more cuts indicating the constraints. A cut can restrict the search space to a corresponding feasible search space that may include a solution. The system may obtain a feasible solution without determining an optimal solution in the search space. In some embodiments, the searching mechanism is expressed as a mixed-integer linear program (MILP). The MILP can then be solved using a solver that facilitates the searching mechanism. With existing technologies, a typical tree-based search may need to keep track of the constraints and the partial order (e.g., book keeping), and maintain a table indicating the dependencies among the constraints. In contrast, the MILP can embed the partial order and constraints. As a result, the MILP can facilitate an efficient traversal through the search space without book keeping or maintaining a table.

HM process planning may refer to facilitating an efficient and compact search for finding one or more optimized, near-optimal, or optimal HM plans, or any distinguished subset of cost-effective plans. More specifically, a search space can be restricted based on an efficient representation of the set of feasibility constraints, thereby resulting in an efficient search for cost-effective, near-optimal, or optimal plans.

### System Architecture

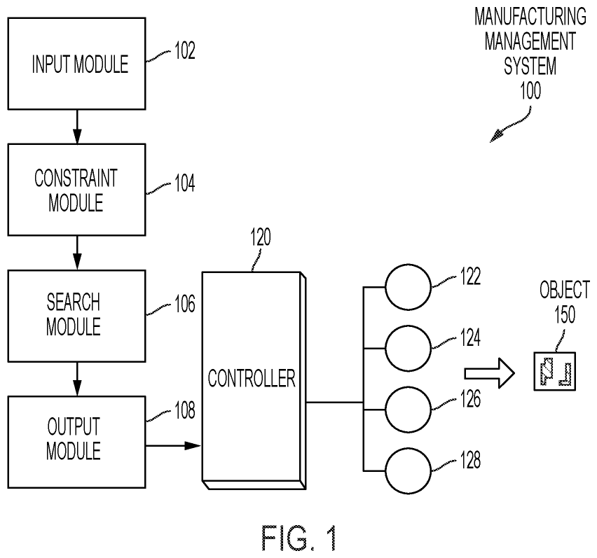

FIG. 1 illustrates an exemplary manufacturing management system for determining an efficient HM process plan, in accordance with an embodiment of the present application. In the example shown in FIG. 1, a manufacturing management system 100 can include an input module 102 that can define a set of manufacturing primitives, atoms, and desired as-manufactured configuration in terms of active and inactive atoms, e.g., atoms that are included and excluded from the desired final state. In some embodiments, a constraint module 104 of system 100 can generate a set of constraints that can restrict the order in which the AM/SM actions, using AM/SM primitives, may appear in a feasible HM process plan. These constraints are input to a search module 106, which can traverse one or more HM process plans that satisfy those constraints and determine a sequence that can satisfy an objective. In some embodiments, the constraints and the objective may be directly given as input to search module 106.

Primitives can be grouped into two categories: AM primitives and SM primitives. An AM or SM primitive can characterize the region of influence of a manufacturing action. The shape of the ROI is determined by the shape of the target design and the manufacturing capability (e.g., 3D printing, milling, or turning). For the purpose of defining the constraints, an as-designed object 150 that is to be manufactured can be divided into volumetric regions called atoms, each of which can have a different shape and size. Specifically, an atom can represent a volumetric region in the Euclidean space that is classified as completely inside or outside against all primitives, i.e., the one or more primitives that include that atom will add/remove the atom upon the AM/SM action, respectively.

Furthermore, a cost model can be defined for adding or removing material during the process of manufacturing object 150. For example, a simple cost multiplier factor for each primitive can be used so that the cost of removing or adding a unit of volume can be proportional to the unit of volume. Hence, the cost of adding or removing a given atom is computed by multiplying the cost factor of the primitive that adds or removes that atom by the volume of the atom. Other embodiments with different cost models are possible without affecting the remaining parts of the method. For example, more sophisticated cost models may be employed that depend on build direction, support structure, layer thickness, minimum feature size, temperature history, material properties, and deposition trajectory (for AM); accessibility, feed and speed, tool path, tool/machine wear and tear, operator time, and fixturing (for SM); and hybridization parameters such as cost of changing from one fixturing setup or machine to another.

Moreover, search module 106 can explore the search space to find total sequences that satisfy the constraints defined for the primitives. Search module 106 can determine a solution in the search space based on one or more searching mechanisms, such as cutting plane methods, branch and bound method, and branch and cut method. In one embodiment, search module 106 can enumerate all feasible plans, with or without ranking the sequences based on their respective cost. System 100 can then apply an output module 108 to identify and output at least one HM process plan, e.g., one or a few of the most cost-effective feasible plans, or a ranked set of many or all feasible plans.

Output module 108 can provide the HM process plan to a controller 120 (e.g., a control system) that can control the execution of a number of manufacturing devices 122, 124, 126, and 128. In some embodiments, system 100 can include controller 120. A respective manufacturing device can operate in a pre-determined trajectory and perform a corresponding manufacturing operation. The manufacturing operation can generate a corresponding primitive associated with object 150. Controller 120 can execute the manufacturing operations of devices 122, 124, 126, and 128 in a sequence provided by the HM process plan. In other words, each device is associated with a primitive, and the sequence of the primitives dictates the order at which the operations of devices 122, 124, 126, and 128 are applied to manufacture object 150.

### Example of a Hybrid-Manufacturing Process Plan

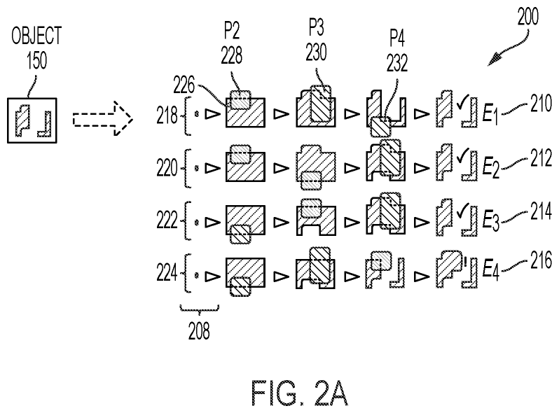

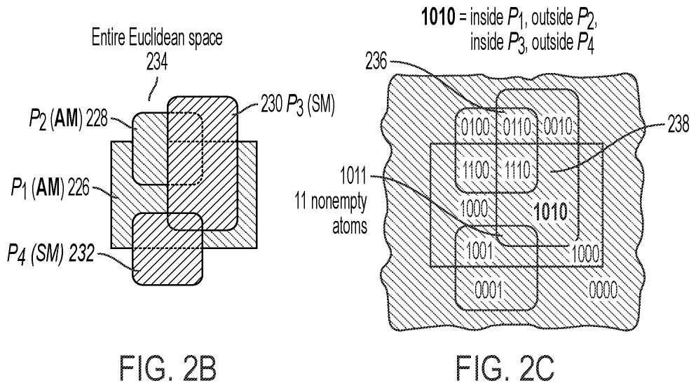

FIG. 2A illustrates exemplary schematics of different HM process plans based on different sequences of a set of manufacturing primitives, in accordance with an embodiment of the present disclosure. In this example, a number of hybrid-manufacturing plans 218, 220, 222, and 224 can be present in a search space 200 for producing object 150.

A respective plan may include a different sequence or ordering of primitives {P₁ 226, P₂ 228, P₃ 230, P₄ 232}. For example, primitives 226 and 228 can correspond to additive manufacturing operations, while primitives 230 and 232 can correspond to subtractive manufacturing operations. Each plan may start with an empty space 208, and a first additive primitive 226 in each of the four plans can add a block of material to empty space 208. For plan 218, after adding a block of material using additive primitive 226, another block of material can be added using additive primitive 228. Then subtractive primitives 230 and 232 are applied sequentially to obtain a desired end state 210, which corresponds to object 150. Plans 220 and 222 apply a different ordering of the primitives to get to the same desired end states 212 and 214, respectively. However, the ordering of the primitives applied for plan 224 can result in a different final state 216 when compared to the desired/target final state 210. Therefore, proper ordering of the primitives is important in planning an HM process for manufacturing a target shape.

FIG. 2B illustrates an exemplary schematic of overlapping the set of manufacturing primitives, in accordance with one embodiment of the present disclosure. The overlapping of primitives P₁ 226, P₂ 228, P₃ 230, P₄ 232 in the Euclidean space 234 dictates how a respective atom may appear. In other words, the regions of overlap among the primitives in the Euclidean space 234 can be represented as a number of atoms.

FIG. 2C illustrates an exemplary schematic of a plurality of manufacturing atoms that result from the intersection of the set of manufacturing primitives and their complements, in accordance with one embodiment of the present disclosure. The binary expressions represent different spatial volumes resulting from overlap among primitives {P₁ 226, P₂ 228, P₃ 230, P₄ 232}. In other words, a respective binary code can correspond to an atom. For example, a subtractive primitive 230 removes five atoms at one time represented by {0110, 1110, 1010, 1011, 0010}, where atom 236, which is ended as 0110, indicate the volumetric region that is outside of P₁ 226, inside of P₂ 228, inside of P₃ 230, and outside of P₄ 232. Similarly, atom 238, which is ended as 1010, indicate the volumetric region that is inside of P₁ 226, outside of P₂ 228, inside of P₃ 230, and outside of P₄ 232.

In the same way, 1110, 1011, and 0010 can encode the other atoms in terms of their inclusions against all primitives, all of which can have their third digit commonly equal to 1 because they are inside of primitive P₃ 230. In other words, each primitive can add or remove a group of atoms together, where each atom is described by a binary string (0 or 1 bits) that represents its inclusion (outside or inside, respectively) against all primitives. When an HM system applies a correct ordering of the given primitives to manufacture the target shape, the system can achieve the end goal of having every atom inside the target shape present and every atom outside the target shape absent at the end of a process plan.

### Traversal of the Search Space

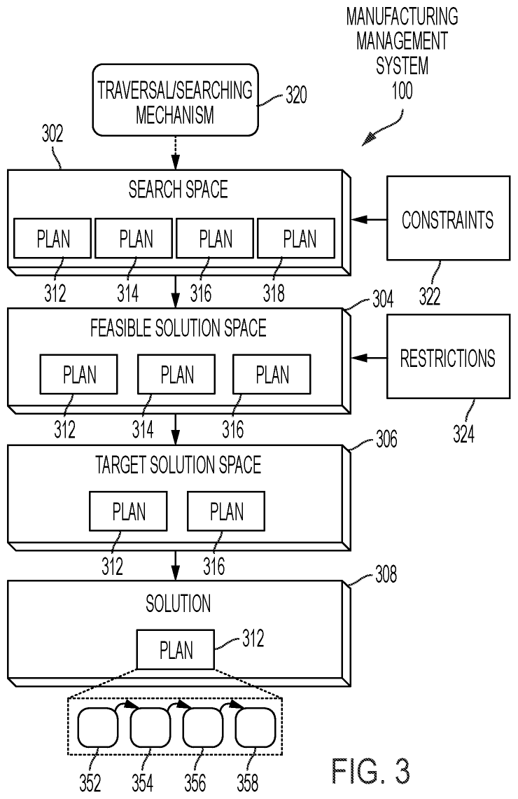

FIG. 3 illustrates an exemplary process of determining an efficient HM process plan, in accordance with an embodiment of the present application. To efficiently manufacture an object, system 100 need to select an HM plan that can include a sequence of primitives that can produce (or manufacture) the object. To do so, system 100 can determine a search space 302 comprising a set of HM process plans, each represented by a corresponding sequence of operations (or sequences), as described in conjunction with FIG. 2A. For example, search space 302 can include a number of plans 312, 314, 316, and 318. System 100 can apply a traversal or searching mechanism 320, such as the simplex algorithm, the cutting plane method, the branch and bound method, or the branch and cut method. Searching mechanism 320 can search for an HM plan, comprising a sequence of primitives, from search space 302 based on an objective. For example, the objective can be finding an HM plan with the minimum cost (e.g., manufacturing, energy consumption, or execution cost).

However, some plans in search space 302 may not be feasible for producing the object. In the example in FIG. 2A, HM plan 224 may not be feasible to produce object 150. System 100 can then apply a set of constrains 322 to search space 302 to generate a feasible solution space 304. For example, a constraint can indicate that if an atom from an AM primitive is added at a particular step of the sequence, the corresponding atom should not be present during the preceding steps. Similarly, another constraint can indicate that if an atom from a PM primitive is removed at a particular step of the sequence, the corresponding atom should be present prior to that step. In this way, constrains 322 restricts search space 302. Therefore, feasible solution space 304 may include fewer numbers of plans 312, 314, and 316.

In some embodiments, system 100 can apply a set of restrictions 324 (e.g., the first operation should be an AM operation) to restrict feasible solution space 304 and generate a target solution space 306. Restrictions 324 can also include relaxation techniques, such as removal of integrality and column generation. Due to the further restrictions, target solution space 306 may include fewer numbers of plans 312 and 316. By applying searching mechanism 320 on target solution space 306, system 100 can continue to traverse target search space 306 as long as at least one solution 308 can be found. In this way, system 100 can efficiently determine solution 308. Searching mechanism 320 may select plan 312 as solution 308 because plan 312 may produce a desired objective value (e.g., a minimum cost). It should be noted that solution 308 may be a feasible solution and not an optimal solution. Plan 312 can include a sequence of primitives 352, 354, 356, and 358.

In some embodiments, the searching mechanism is expressed as an MILP, which can be solved based on searching mechanism 320. Suppose that the set of all primitives (e.g., the set comprising primitives 352, 354, 356, and 358) can be indicated by [symbol] ={1, . . . , N}. All atoms that can produce the object can be indicated by [symbol] . System 100 may determine the sequence of all primitives (e.g., primitives 352, 354, 356, and 358 in solution 308) such that the object can be manufactured, as indicated by z^{a} ε {0,1}, ∀ a ε [symbol] ⊂ [symbol] . Here, z^{a} can indicate whether an atom a is generated by a corresponding primitive in the manufactured object. As discussed in conjunction with FIGS. 2A-2C, the primitives can be divided into two non-empty disjoint subsets, the AM primitives, [symbol] ₐ, and the SM primitives, [symbol] ₛ. Suppose that pᵢ^{a} ε {0,1} can indicate the inclusion of atom a in the primitive i. Hence, if pᵢ^{a}=1, then atom a can be added or subtracted by the corresponding primitive i.

Accordingly, the volume corresponding to atom a can be indicated by vₐ>0, ∀a ε [symbol] . If the cost associated with a respective primitive i can be indicated by wᵢ>0, ∀i ε [symbol] , for a given set of w, p, z, and v, system 100 can determine an efficient sequence of operations from their corresponding primitives that can satisfy the objective. For example, the objective can be the minimum volumetric cost resulting from adding and subtracting materials during the manufacturing process. To ensure efficiency, system 100 may not use a primitive more than once. A feasible plan (e.g., a plan in feasible search space 304) may include a subset of M≤N primitives. An index k can indicate the order or sequence in which the primitives are applied. Hence, the first primitive to be applied can correspond to k=1.

Suppose that xⁱₖ ε {0,1}, ∀i ε [symbol] , k=1, . . . , M can indicate whether the i^{th} primitive is going to be applied at the k^{th} step of the sequence. For example, xₖⁱ=1 can assert the application of the i^{th} primitive at the k^{th} step. The application of at least one primitive at a respective step can be described by:

$${\sum }_{i ∈} {x}_{k}^{i} = 1 , ∀ k = 1 , … , M \qquad ( 1 )$$

Furthermore, the restriction of a respective primitive not being applied more than once can be described as:

$${\sum }_{k = 1}^{M} {x}_{k}^{i} \leq 1 , ∀ i ∈ \qquad ( 2 )$$

Furthermore, the manufacturing staring with an addition can be described as:

$${\sum }_{i ∈ {a}_{}} {x}_{1}^{i} = 1 \qquad ( 3 )$$

If zₖ^{a} ε {0,1} indicates whether an atom a is active after the k^{th} step, system 100 can enforce the feasibility of the HM plan (manufacturability) by:

z_{N}^{a}=z^{a},∀aε [symbol] (4)

After an atom is allocated for k^{th} step, zₖ^{a} can be updated as:

$${z}_{k}^{a} = {z}_{k - 1}^{a} + ( 1 - {z}_{k - 1}^{a} ) {\sum }_{i ∈ {a}_{}} {x}_{k}^{{i}_{}} {p}_{i}^{a} - {z}_{k - 1}^{a} {\sum }_{i ∈ {s}_{}} {x}_{k}^{i} {p}_{i}^{a} , \qquad ( 5 )$$

$$∀ a ∈ , k = 1 , … , M$$

In other words, if atom a is has not be generated before the k^{th} step and the corresponding primitive i is an AM primitive, atom a is added if pᵢ^{a}=1. Similarly, if atom a is present before the k^{th} step and the corresponding primitive i is an SM primitive, atom a is removed if pᵢ^{a}=1. If neither of these conditions is satisfied, the status of atom a can remain unchanged at the k^{th} step. To indicate the beginning of the manufacturing process, the recursion of Equation (5) can be initialized with z₀^{a}=0, ∀a ε [symbol] . Here, z₀^{a}=0 can indicate that the manufacturing process can start from scratch.

Next, system 100 can determine the weighted volumetric change associated with the k^{th} step. If Vₖ>0 can indicate the cumulative weighted volumetric change that occurs as a result of the first k steps. Accordingly, the weighted volumetric change can be indicated by:

$${V}_{k} = {V}_{k - 1} + {\sum }_{a ∈} {v}_{a} [ ( 1 - {z}_{k - 1}^{a} ) {\sum }_{i ∈ {a}_{}} {x}_{k}^{i} {w}_{i} {p}_{i}^{a} + {z}_{k - 1}^{a} {\sum }_{i ∈ {S}_{}} {x}_{k}^{i} {w}_{i} {p}_{i}^{a} ] , \qquad ( 6 )$$

$$k = 1 , … , M$$

Here, system 100 can add or subtract the volume associated with atom a that contributes to the change in volume after the corresponding step. The recursion of Equation (6) with V₀=0.

The objective can then be described as

$${C}^{*} = {min}_{x , z , V} {V}_{N}$$

subject to constraints expressed in Equations (1)-(6). It should be noted that the set of constraints indicated in Equations (5) and (6) are non-linear due to the appearance of terms with multiplication of variables x and z. To efficiently perform the searching operation, Equations (5) and (6) can be expressed in respective linear forms using an auxiliary indicator yₖ^{i,a} ε {0,1} such that

yₖ^{i,a}=zₖ₋₁^{a}xₖⁱ,∀aϵ [symbol] ,550 iϵ [symbol] ,k=1, . . . , M (7)

Equation (7) can be expressed using the following equivalent set of linear constraints:

yₖ^{i,a}≤zₖ₋₁^{a},∀iϵ [symbol] ,k=1, . . . , M,aϵ [symbol] (8)

yₖ^{i,a}≤xₖⁱ,∀iϵ [symbol] ,k=1, . . . , M,aϵ [symbol] (9)

yₖ^{i,a}≥zₖ₋₁^{a}′xₖⁱ−1∀iϵ [symbol] ,k=1, . . . , N,aϵ [symbol] (10)

Hence, Equation (5) can be expressed as

$${z}_{k}^{a} = {z}_{k - 1}^{a} + {\sum }_{i ∈ {a}_{}} ( {x}_{k}^{i} - {y}_{k}^{i , a} ) {p}_{i}^{a} - {\sum }_{i ∈ {s}_{}} {y}_{k}^{i , a} {p}_{i}^{a} , \qquad ( 11 )$$

$$∀ a ∈ , k = 1 , … , M$$

where z₀^{a}=0, ∀a ϵ [symbol] . Similarly, where V₀=0, the volumetric cost update in Equation (6) can be expressed as:

$${V}_{k} = {V}_{k - 1} + {\sum }_{a ∈} {v}_{a} [ {\sum }_{i ∈ {a}_{}} ( {x}_{k}^{i} - {y}_{k}^{i , a} ) {w}_{i} {p}_{i}^{a} + {\sum }_{i ∈ {s}_{}} {y}_{k}^{i , a} {w}_{i} {p}_{i}^{a} ] , \qquad ( 12 )$$

$$∀ a ∈ , k = 1 , … , M$$

Therefore, the objective can then be described as

$${C}^{*} = {min}_{x , y , z , V} {V}_{N}$$

subject to linear constraints expressed in Equations (1)-(4) and (8)-(12).

In some embodiments, searching mechanism 320 can include cutting plane methods. To efficiently perform the searching operation, restrictions 324 can be applied to further reduce feasible solution space 304, thereby reducing the computational overhead. For example, restrictions 324 can indicate that, at each step k, an AM primitive i can be used if the corresponding atom a enforces z^{a}=1, pᵢ^{a}=1, and zₖ₋₁^{a}=0. Similarly, restrictions 324 can also indicate that, at each step k, a PM primitive i can be used if the corresponding atom a enforces z^{a}=0, pᵢ^{a}=1, and zₖ₋₁^{a}=1. In other words, at least one atom selected to be included in the object should be added by the corresponding primitive, and at least one atom that should not be part of the object should be removed by the corresponding primitive.

Under such circumstances, the set of all atoms [symbol] with a specification (active or inactive) in the object can be described as the union of two disjoint sets, [symbol] ₐ and [symbol] ᵢ representing the set of all atoms that are included and excluded in the object during the manufacturing process. Therefore, atom a can be in [symbol] ₐ if z^{a}=1, and atom a can be in [symbol] ᵢ if z^{a}=0. Accordingly, restrictions 324 can impose:

$${x}_{k}^{i} \leq {\sum }_{a ∈ {a}_{}} ( 1 - {z}_{k - 1}^{a} ) {p}_{i}^{a} , ∀ i ∈ {a}_{} , k = 1 , … , M \qquad ( 13 )$$

$$and$$

$${x}_{k}^{i} \leq {\sum }_{a ∈ {i}_{}} {z}_{k - 1}^{a} {p}_{i}^{a} , ∀ i ∈ {s}_{} , k = 1 , … , M \qquad ( 14 )$$

For the first step, k=1, z₀^{a}=0∀a, restrictions 324 can also impose:

$${x}_{1}^{i} \leq {\sum }_{a ∈ {a}_{}} {p}_{i}^{a} , ∀ i ∈ {a}_{} \qquad ( 15 )$$

$$and$$

$${x}_{1}^{i} \leq 0 , ∀ i ∈ {s}_{} \qquad ( 16 )$$

In this way, restrictions 324 can ensure that the first action is an AM primitive that adds at least one atom that is included in the object during the manufacturing process. Based on Equations (13)-(16), system 100 can determine target solution space 306 by restricting feasible solution space 304.

### Operations

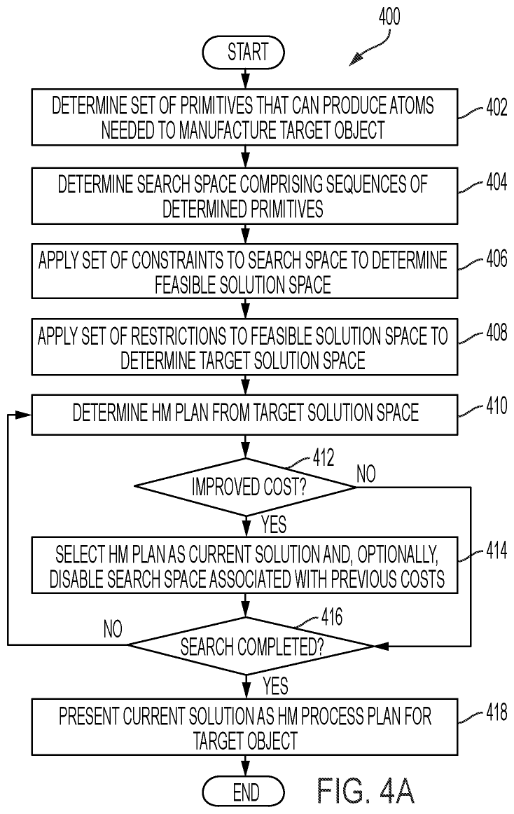

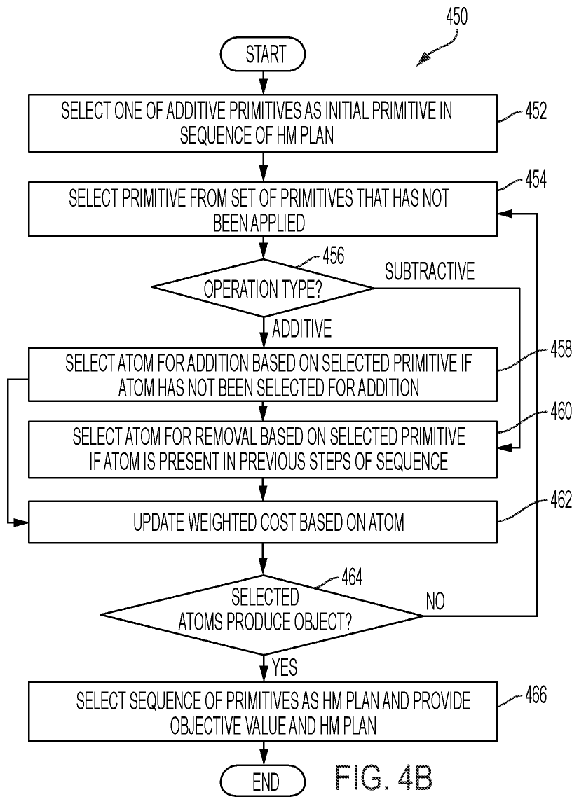

FIG. 4A presents a flowchart illustrating a method 400 of a process management system determining an efficient HM process plan, in accordance with an embodiment of the present application. During operation, the system can determine a set of primitives that can produce the atoms needed to manufacture a target object (operation 402). The system can then determine a search space comprising sequences of determined primitives (operation 404) and apply a set of constraints to the search space to determine a feasible solution space (operation 406). In some embodiments, the system can also apply a set of restrictions to the feasible solution space to determine a target solution space (operation 408). The system can then determine an HM plan from the target solution space (operation 410).

Subsequently, the system can determine whether the HM plan provides an improved cost (e.g., compared to prior search results) (operation 412). If the HM plan provides an improved cost, the system can select the HM plan as the current solution (operation 414). The system can, optionally, disable the search space associated with the previous costs (i.e., previous search branches). If the HM plan does not provide an improved cost (operation 412) or upon selecting the HM plan as the current solution (operation 414), the system can determine whether the search is completed (e.g., whether the cost has converged for a number of iterations) (operation 416). If the search is not completed, the system can then continue to determine an HM plan from the target solution space (operation 410). On the other hand, if the search is not completed, the system can present the current solution as the HM process plan for the target object (operation 418).

FIG. 4B presents a flowchart illustrating a method 450 of a process management system determining a sequence of primitives corresponding to an efficient HM process plan, in accordance with an embodiment of the present application. During operation, the system can determine one of the additive primitives as the initial primitive in the sequence of the HM plan (operation 452). The system can then select a primitive from the set of primitives that has not been applied (operation 454). Subsequently, the system can determine the operation type associated with the selected primitive (operation 456). If the operation is additive, the system can select an atom for addition based on the selected primitive if the atom has not been selected for addition (operation 458).

On the other hand, if the operation is subtractive, the system can select an atom for removal based on the selected primitive if the atom is present in the previous steps of the sequence (operation 460). Upon selecting the atom (operation 458 or 460), the system can update the weighted cost based on the atom (operation 462). The system can then determine whether the selected atoms produce the object (operation 464). If the selected atoms do not produce the object, the system can continue to select a primitive from the set of primitives that has not been applied (operation 454). If the selected atoms produce the object, the system can select the sequence of primitives as the HM plan and provide the objective value and the HM plan (operation 466).

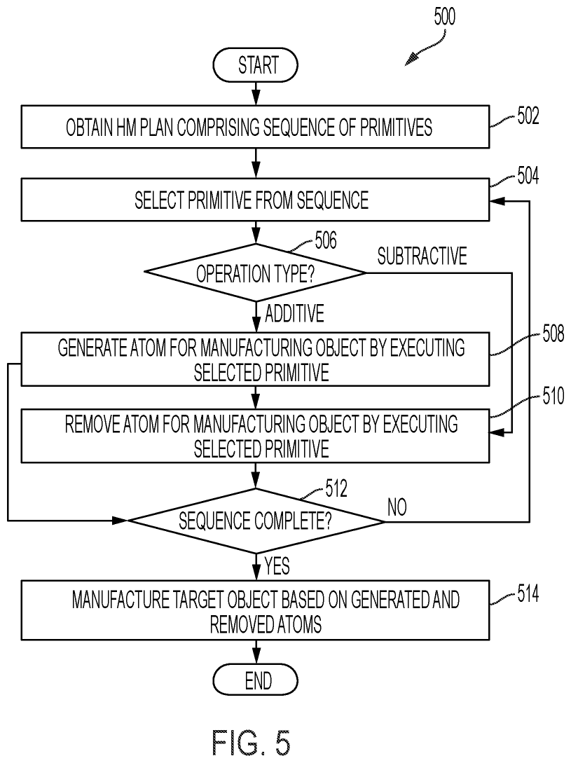

FIG. 5 presents a flowchart illustrating a method 500 of a process management system executing a sequence of manufacturing primitives based on an efficient HM process plan, in accordance with an embodiment of the present application. During operation, the system can obtain an HM plan comprising a sequence of primitives (operation 502) and select a primitive from the sequence (operation 504). Subsequently, the system can determine the operation type associated with the selected primitive (operation 506). If the operation is additive, the system can generate an atom for manufacturing the object by executing the selected primitive (operation 508).

On the other hand, if the operation is subtractive, the system can remove an atom for manufacturing the object by executing the selected primitive (operation 510). Upon performing the operation on the atom (operation 508 or 510), the system can determine whether the sequence is complete (operation 512). If the sequence is not complete, the system can continue to select a primitive from the sequence (operation 504) and perform an operation on the atom associated with the selected primitive. If the sequence is complete, the system can manufacture the target object based on the generated and removed atoms (operation 514). In this way, the system can control the manufacturing process based on the HM process plan and manufacture the target object.

### Exemplary Computer System and Apparatus

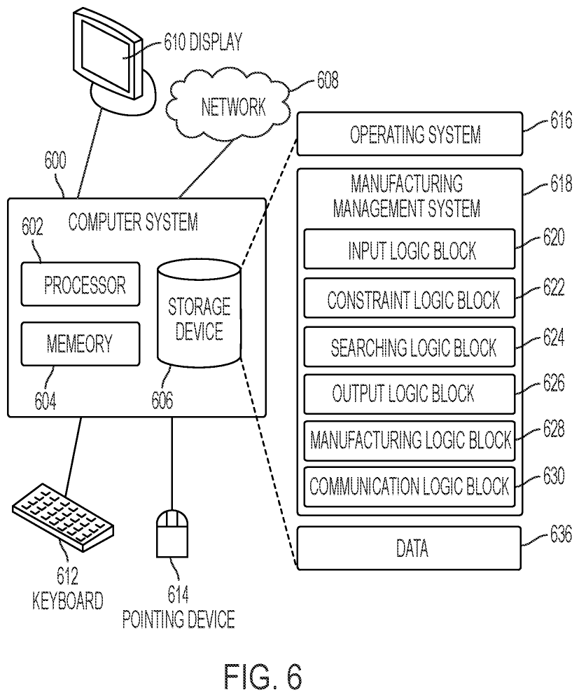

FIG. 6 illustrates an exemplary computer system facilitating a manufacturing management system capable of determining an efficient HM process plan, in accordance with an embodiment of the present application. Computer system 600 includes a processor 602, a memory device 604, and a storage device 606. Memory device 604 can include a volatile memory device (e.g., a dual in-line memory module (DIMM)). Furthermore, computer system 600 can be coupled to a display device 610, a keyboard 612, and a pointing device 614. Computer system 600 can be coupled to a network 608 via a network interface of computer system 600. Storage device 606 can store an operating system 616, a manufacturing management system 618, and data 636. Manufacturing management system 618 can incorporate the operations of system 100.

Manufacturing management system 618 can include instructions, which when executed by computer system 600 can cause computer system 600 to perform methods and/or processes described in this disclosure. Specifically, manufacturing management system 618 can include instructions for obtaining a set of input based on which an HM process plan can be generated (input logic block 620). The input can include a set of primitives associated with a set of manufacturing devices. Manufacturing management system 618 can include instructions for determining the set of atoms based on the overlapping of the primitives (input logic block 620). Manufacturing management system 618 can also include instructions for determining a set of constraints for the search space associated with the manufacturing process (constraint logic block 622). In some embodiments, manufacturing management system 618 includes instructions for determining a set of restrictions (constraint logic block 624).

Manufacturing management system 618 can also include instructions for searching a target search space restricted by the constraints and the restrictions (searching logic block 624). The searching operation can be performed based on one or more of: the simplex algorithm, cutting plane methods, the branch and bound method, and the branch and cut method. The searching operation can be facilitated by a mixed-integer linear programming solver. Manufacturing management system 618 can also include instructions for generating an output (e.g., an HM process plan) based on the searching and presenting the output to a user interface (output logic block 626). The user interface can be a textual, web, graphical, or virtual-reality interface of computer system 600.

Manufacturing management system 618 can further include instructions for controlling a set of manufacturing devices, each of which can correspond to a primitive (manufacturing logic block 628). Manufacturing management system 618 can then include instructions for controlling the execution of a set of manufacturing operations corresponding to a sequence of primitives in an HM process plan (manufacturing logic block 628). Manufacturing management system 618 may further include instructions for sending and receiving messages (e.g., packets and frames) (communication logic block 630).

Data 636 can include any data that can facilitate the operations of system 100. Data 736 may include one or more of: information associated with a set of primitives that can manufacture an object, a set of atoms corresponding to the set of primitives, inputs to the searching mechanism, and a linear program representing the search.

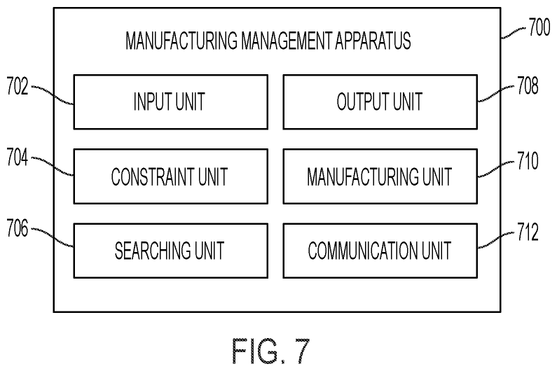

FIG. 7 illustrates an exemplary apparatus that facilitates a manufacturing management system capable of determining an efficient HM process plan, in accordance with an embodiment of the present application. Manufacturing management apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device that is capable of communicating with other computer systems and/or devices. Specifically, apparatus 700 can comprise units 702-712, which perform functions or operations similar to modules 620-630 of computer system 600 of FIG. 6, including: an input unit 702; a constraint unit 704; a searching unit 706; an output unit 708; a manufacturing unit 710; and a communication unit 712.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating a process plan for manufacturing an object, the method comprising:
determining, by a computer, a target search space based on a set of constraints, wherein the target search space includes a set of manufacturing actions associated with a manufacturing process of the object, and wherein a respective manufacturing action includes an additive or subtractive manufacturing operation corresponding to addition or removal of a predefined region of the object, respectively;
traversing a set of sequence of actions in the target search space based on a search operation, wherein a respective sequence of actions includes one or more manufacturing operations capable of producing the object;
selecting, from the set of sequence of actions, a sequence of actions as the process plan, wherein the selected sequence of actions satisfies a target objective; and
providing the process plan to a controller configured to manage the manufacturing process of the object.

2. The method of claim 1, wherein a respective manufacturing operation corresponds to a primitive indicating a three-dimensional (3D) region of influence (ROI) for the object.

3. The method of claim 2, wherein intersections of a set of primitives associated with the set of manufacturing actions indicate a plurality of atoms, and wherein a respective atom indicates whether the atom is included in a respective of the set of primitives.

4. The method of claim 1, wherein determining the target search space further comprises applying a set of restrictions on the search space associated with the manufacturing process of the object.

5. The method of claim 4, wherein the set of restrictions comprises one or more of: a predefined order of a subset of manufacturing operations and an enhancement to the search operation.

6. The method of claim 1, further comprising:
generating a structured representation of the search operation based on the set of constraints; and
performing the search operation based on a solver using the structured representation.

7. The method of claim 6, wherein the structured representation is a linear program, and the solver includes a mixed integer linear programming solver.

8. The method of claim 1, wherein the search operation includes one or more of: a simplex algorithm, a cutting plane method, a branch and bound method, and a branch and cut method.

9. The method of claim 1, wherein selecting the sequence of actions further comprises:
determining a weighted volumetric cost for a respective of the set of sequence of actions; and
determining that the volumetric cost for the sequence of actions satisfies the target objective.

10. The method of claim 1, further comprising controlling execution of the one or more manufacturing operations in an order indicated by the sequence of actions.

11. A computer system, comprising:
a processor; and
a storage device coupled to the processor and storing instructions, which when executed by the processor cause the processor to perform a method for facilitating a process plan for manufacturing an object, the method comprising:
determining, by a computer, a target search space based on a set of constraints, wherein the target search space includes a set of manufacturing actions associated with a manufacturing process of the object, and wherein a respective manufacturing action includes an additive or subtractive manufacturing operation corresponding to addition or removal of a predefined region of the object, respectively;
traversing a set of sequence of actions in the target search space based on a search operation, wherein a respective sequence of actions includes one or more manufacturing operations capable of producing the object;
selecting, from the set of sequence of actions, a sequence of actions as the process plan, wherein the selected sequence of actions satisfies a target objective; and
providing the process plan to a controller configured to manage the manufacturing process of the object.

12. The computer system of claim 11, wherein a respective manufacturing operation corresponds to a primitive indicating a three-dimensional (3D) region of influence (ROI) for the object.

13. The computer system of claim 12, wherein intersections of a set of primitives associated with the set of manufacturing actions indicate a plurality of atoms, and wherein a respective atom indicates whether the atom is included in a respective of the set of primitives.

14. The computer system of claim 11, wherein determining the target search space further comprises applying a set of restrictions on the search space associated with the manufacturing process of the object.

15. The computer system of claim 14, wherein the set of restrictions comprises one or more of: a predefined order of a subset of manufacturing operations and an enhancement to the search operation.

16. The computer system of claim 11, wherein the method further comprises:
generating a structured representation of the search operation based on the set of constraints; and
performing the search operation on a solver based on the structured representation.

17. The computer system of claim 16, wherein the structured representation is a linear program, and the solver includes a mixed-integer linear programming solver.

18. The computer system of claim 11, wherein the search operation includes one or more of: a simplex algorithm, a cutting plane method, a branch and bound method, and a branch and cut method.

19. The computer system of claim 11, wherein selecting the sequence of actions further comprises:
determining a weighted volumetric cost for a respective of the set of sequence of actions; and
determining that the volumetric cost for the sequence of actions satisfies the target objective.

20. The computer system of claim 11, wherein the method further comprises controlling execution of the one or more manufacturing operations in an order indicated by the sequence of actions.
